(19) United States
(12) Patent Application Publication
(10) Pub. No.: US 2014/0118616 A1
(43) Pub. Date: May 1, 2014

(54) Systems and Methods of Video Delivery to a Multilingual Audience

(71) Applicant: COX COMMUNICATIONS, INC., Atlanta, GA (US)

(72) Inventors: Zouhir Zack Oughriss, Lawrenceville, GA (US); Ray Killick, Alpharetta, GA (US)

(73) Assignee: COX COMMUNICATIONS, INC., Atlanta, GA (US)

(21) Appl. No.: 13/662,400

(22) Filed: Oct. 26, 2012

(51) Int. Cl. H04N 7/025

(52) U.S. Cl. 348/462; 348/E07.017

(57) ABSTRACT

Disclosed herein is simultaneous processing of multiple MPEG audio packetized elementary streams (PES). Each audio PID gets processed separately, substantially simultaneously. Example embodiments of the systems and methods of video delivery to a multilingual audience disclosed herein enable the processing of two or more audio tracks within the same transport stream simultaneously and deliver each audio to separate audio outputs where one of the outputs may be going to a wireless headset, a secondary room or a secondary screen. The main language audio (PES) is rendered with the video on the main screen, or the different audio streams may be rendered concurrently in different rooms such as in a business application. The main screen would have the main video along with its original language audio while the dubbed audio will be processed and played at the same time with the original video.

### TECHNICAL FIELD

The present disclosure is generally related to video delivery systems and, more particularly, is related to video delivery with multiple audio streams.

### BACKGROUND

A Moving Pictures Expert Group (MPEG) transport stream (MPEG-TS, MTS or TS) is a standard format for transmission and storage of audio, video, and Program and System Information Protocol (PSIP) data. The MPEG format is widely used in broadcast systems such as digital video broadcasting (DVB), Advanced Television Systems Committee (ATSC) and Internet Protocol Television (IPTV). The MPEG transport stream is specified in MPEG-2 Part 1, Systems (formally known as ISO/IEC standard 13818-1 or ITU-T Rec. H.222.0).

The transport stream specification specifies a container format encapsulating packetized elementary streams, with error correction and stream synchronization features for maintaining transmission integrity when the signal is degraded. Transport streams differ from the similarly named program streams in several important ways: program streams are designed for reasonably reliable media, such as discs (like DVDs), while transport streams are designed for less reliable transmission, namely terrestrial or satellite broadcasts. Further, a transport stream may carry multiple programs.

A packet is the basic unit of data in a transport stream. It starts with a sync byte and a header. Additional optional transport fields, as signaled in the optional adaptation field, may follow. The rest of the packet consists of payload. Packets are 188 bytes in length, but the communication medium may add some error correction bytes to the packet. ISDB-T and DVB-T/C/S uses 204 bytes and ATSC 8-VSB uses 208 bytes as the size of emission packets (transport stream packet+FEC data).

Each table or elementary stream in a transport stream is identified by a 13-bit packet ID (PID). A demultiplexer extracts elementary streams from the transport stream in part by looking for packets identified by the same PID. In most applications, time-division multiplexing will be used to decide how often a particular PID appears in the transport stream.

A transport stream has a concept of programs. Each single program is described by a Program Map Table (PMT) which has a unique PID, and the elementary streams associated with that program have PIDs listed in the PMT. For instance, a transport stream used in digital television might contain three programs to represent three television channels. Suppose each channel consists of one video stream, one or two audio streams, and any necessary metadata. A receiver wishing to decode a particular “channel” decodes the payloads of each PID associated with its program. It can discard the contents of all other PIDs. A transport stream with more than one program is referred to as MPTS—Multi Program Transport Stream. A single program transport stream is referred to as SPTS—Single Program Transport Stream. There are heretofore unaddressed needs with previous solutions in simultaneously providing multiple audio streams to users with a video stream from a transport stream.

### SUMMARY

Example embodiments of the present disclosure provide systems of video delivery to multilingual audiences. Briefly described, in architecture, one example embodiment of the system, among others, can be implemented as follows: a program stream decoder configured to separate a video stream and a plurality of associated audio streams; and an audio stream module configured to output at least two of the plurality of associated audio streams substantially simultaneously.

Embodiments of the present disclosure can also be viewed as providing methods for video delivery to multilingual audiences. In this regard, one embodiment of such a method, among others, can be broadly summarized by the following steps: receiving a program stream with video packets and audio packets, the audio packets comprising at least a first language and a second language; substantially simultaneously processing the audio packets comprising the first language and the audio packets comprising the second language; and outputting the audio packets comprising the first language for use by a first user and the audio packets comprising the second language for use by a second user, the audio packets comprising the first language and the audio packets comprising the second language being output substantially simultaneously and synchronously with the video packets.

### BRIEF DESCRIPTION OF THE DRAWINGS

FIG. 1 is a block diagram of an example embodiment of a video delivery system.

FIG. 2 is a block diagram of an example embodiment of a system of video delivery to multilingual audiences.

FIG. 3 is a flow diagram of an example embodiment of a method of video delivery to multilingual audiences.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

The systems and methods of video delivery to a multilingual audience disclosed herein enable the audience to watch the same movie or content in different languages simultaneously in such a way that family members with different tongues within the same household or venue can watch the same video program together without adverse impact on one another's experience.

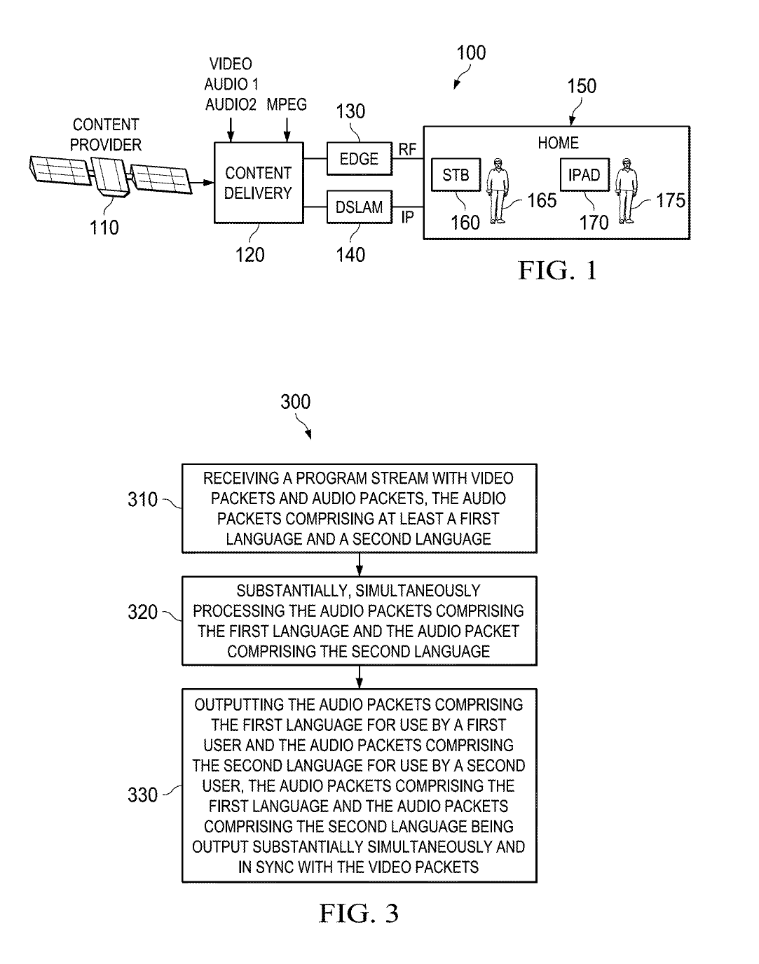

Currently, in content delivery network 100 as provided in FIG. 1, the content is received from content provider 110 through a satellite dish, for example. Content delivery device 120 receives the content and broadcasts it to Enhanced Data rate for GSM Evolution (EDGE) device 130 and/or the content stream, such as an MPEG2 stream, may be transmitted to a digital subscriber line access multiplexer (DSLAM) that may transmit using Internet Protocol (IP), cable modem termination system (CMTS), and Data Over Cable Service Interface Specification (DOCSIS) as non-limiting examples. EDGE device 130 or DSLAM 140 may then transmit the content to an end-user device in home 150. Non-limiting examples of end-user devices are internet protocol set-top box 170 for user 175 and set-top box 160 for user 165.

In an example embodiment, the incoming content comprises video (which is the image that will be rendered on the iPad, for example) and multiple audio streams (for example, seven audio streams synchronized with the single video stream). A particular end user may speak a particular language, whether English, Spanish, Chinese, etc. However, multilingual families and businesses may have a need to watch/broadcast the same video in multiple languages. If a user wants to watch a given video, she would make a decision as to what language she wishes to listen to—for example, Spanish. Another person may choose English. But, presently, these two viewers cannot be in the same room or in different rooms watching the same video in different languages. The content provider may provide at least Audio1 and Audio2 to the EDGE device. Once it is received by the EDGE device, example embodiments of the systems and methods of video delivery to a multilingual audience disclosed herein process one audio and provide it to one viewer, and process a second audio and provide it to the other viewer. The disclosed systems and methods compel content providers to create more multilingual content than ever before.

When different people request a movie, one particular audio stream (language) may be included with the video. So, in general, if one person wants a version in English and one person wants the movie in French, two different movies are requested. The users request Video1 with Audio1 and Video2 with Audio2. Using the systems and methods of video delivery to multilingual audiences disclosed herein, one video is sent with multiple audio streams and they are decoded separately at the End User device. For instance, one person could listen to the movie in English through the device speakers and another person could listen to the movie in Spanish on a headset. The video may be viewed in the same room or in different rooms.

The MPEG structure includes a video stream and at least two audio Packet Identifiers (PIDS). Previously, those two audio PIDs would not be processed simultaneously. The end device usually only processes one audio output. The channel input is received by the set-top box, for example, or the digital playback equipment, and is decoded by the MPEG decoder. The audio is selected with some user interface or configuration setting, for example. The audio goes to either a speaker or wireless transmitter and could be output as the main TV or wirelessly, received by wireless headphones or wireless devices.

Example embodiments of the systems and methods of video delivery to a multilingual audience disclosed herein break the language barrier by enabling households, movie theaters and corporations doing business across continents, among others, to address multi-lingual audiences concurrently. In addition, storage and bandwidth conservation may be achieved by consolidating audio elementary streams within the same MPEG content stream as opposed to creating distinct copies per language. The systems and methods of video delivery to a multilingual audience disclosed herein enable an internet service provider to fast forward to a future that will inevitably bring this type of service to audiences worldwide.

Example embodiments of the systems and methods of video delivery to a multilingual audience disclosed herein may be implemented on a TV, set-top box, iPad, iPhone, PC or Mac, Xbox, and other devices with audio/video technology. They can be leveraged for the household as well as public venues such as non-limiting examples of the United Nations, movie theaters, businesses and public news channels.

Example embodiments of the systems and methods of video delivery to a multilingual audience disclosed herein enable the rendering of a movie or video program with two or more audio packetized elementary streams (PES) to be played simultaneously to an audience comprised of multi-lingual viewers. Currently, no technology exists that provides simultaneous audio feeds accompanying a single video stream to an audience of multilingual speakers. Even though an MPEG2 single program transport stream (SPTS) may contain distinct audio paths (PES), only a single audio elementary stream is played at a time based on the viewer's choice. Currently multiple audios for the same video program cannot be played simultaneously without creating a cacophony of sorts. Currently, all of the existing audio/video players such as set-top boxes do not have the capability of playing a video content which contains multiple audio tracks/PIDs in such a way that two or more audios can be simultaneously played. However, with our societies becoming increasingly multilingual the need exists to play different audios for the same movie or content at the same time in such a way that viewers with different tongues in the same household or venue can watch the same video program together without adverse impact on one another's experience.

This innovation is made possible by simultaneous processing of the MPEG audio packetized elementary stream (PES). The MPEG transport stream which contains packetized video and audio elementary streams (PES) often contains an extra audio PID for a second language. Each audio PID gets processed separately, one at a time. Example embodiments of the systems and methods of video delivery to a multilingual audience disclosed herein enable the processing of two or more audio tracks within the same transport stream simultaneously and deliver each audio to separate audio outputs where one of the outputs may be going to a wireless headset, a secondary room or a secondary screen. The main language audio (PES) is rendered with the video on the main screen, or the different audio streams may be rendered concurrently in different rooms such as in a business application. The main screen would have the main video along with its original language audio while the dubbed audio will be processed and played at the same time with the original video providing the secondary audience/viewers the flexibility to watch the movie or program in their spoken tongue.

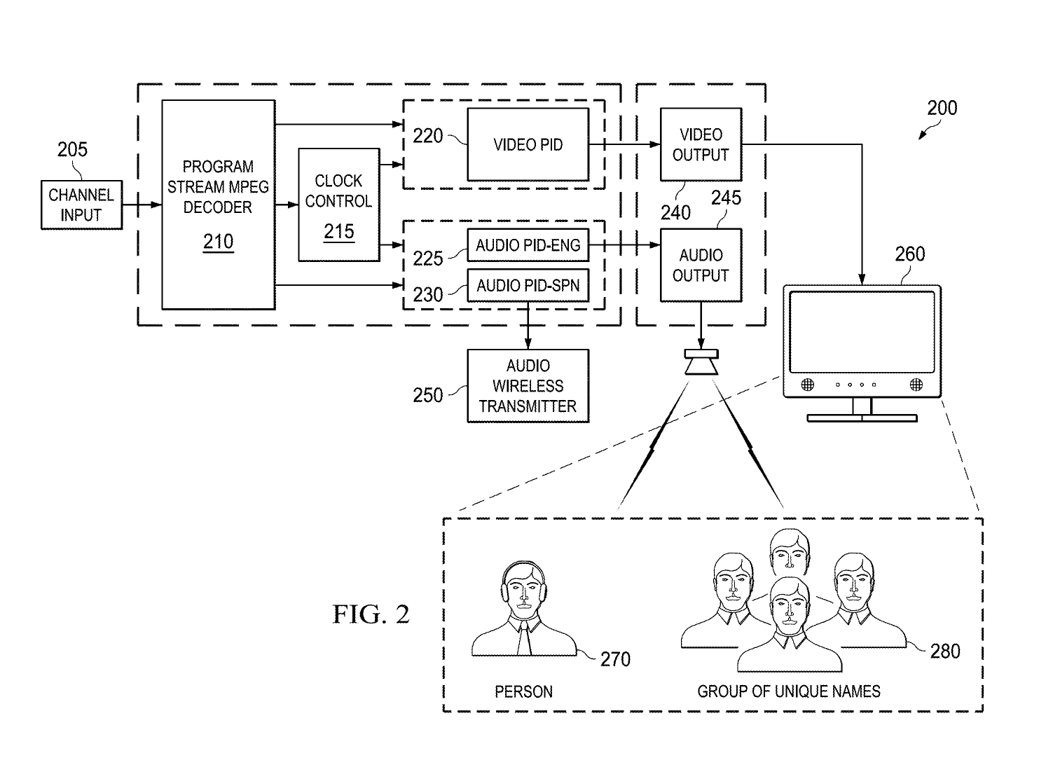

FIG. 2 provides an example embodiment of a system for video delivery for multilingual audiences. In system 200, channel input 205 is received by program system MPEG decoder 210. Program stream MPEG decoder 210 separates the video streams and the audio streams from the MPEG stream. The stream identified by video PID 220 is processed by a video processor and the streams identified by audio PIDS 225 and 230 are processed by an audio processor. Clock controller 215 maintains synchronicity between the video and audio streams. In an example embodiment, video output 240 identified by video PID 220 is sent to display 260. First audio output 245 identified by audio PID 225 is sent to speaker output to be heard by group 280. A second audio output identified by audio PID 230 is sent to audio wireless transmitter 250, which is transmitted to user 270. In this manner, all users including user 270 and group 280, may view the same video content and hear different audio content.

The second audio PES for the second language may be streamed via any wireless technology or provided to a different room from the primary. The secondary audio and the video program may be streamed wirelessly allowing viewers to use their wireless headsets such as WIFI, Bluetooth headphone with total ambient noise cancellation or via IPE/high-speed data link, for example. Alternatively, viewers may also be in separate rooms with their preferred audio without the need of a headset. Channel changes may be implemented through a Picture-in-Picture (PIP) window with audio enabled while the main screen continues to display the current channel with audio muted. While the TV is in PIP mode, viewers may be able to, among other functions, (1) mute the main screen audio (2) sample PIP channels with audio on; (3) toggle the audio between main and PIP screens at will; and (4) carry the multilingual experience in main and PIP screens as described above.

FIG. 3 provides flow chart 300 of an example embodiment of a method of video delivery to a multilingual audience. In block 310, a program stream with video packets and audio packets is received, the audio packets comprising at least a first language and a second language. In block 320, the audio packets comprising the first language and the audio packets comprising the second language are processed substantially simultaneously. In block 330, the audio packets comprising the first language for use by a first user and the audio packets comprising the second language for use by a second user are output, the audio packets comprising the first language and the audio packets comprising the second language are output substantially simultaneously and synchronously with the video packets.

Various advantages may be found in these disclosed systems and methods such as (1) simultaneous audio encoding and processing wherein more than one audio track can be streamed at the same time; (2) simultaneously processing and outputting two or more audio sources into different audio outputs; (3) watching the same video program which contains two or more audio tracks and delivering distinct audios to distinct audiences; (4) adding a second audio feature to a PIP screen wherein the viewer will be able to experience audio from the secondary screen while the primary audio is muted; (5) adding a second audio feature to the PIP screen wherein the viewer will be able to experience audio from the secondary screen while the primary audio is enabled (multilingual experience); (6) transmitting two different audio tracks to from the same source to distinct audiences wherein one audio track is outputted to a primary screen and the other audio is delivered through a wireless audio transmitter/wireless headphone/IP network; and (7) channel changes through PIP window with audio enabled (main window muted), among others.

Although the present disclosure has been described in detail, it should be understood that various changes, substitutions and alterations can be made thereto without departing from the spirit and scope of the disclosure as defined by the appended claims.

1. A system comprising:
a program stream decoder device configured to separate a video stream and a plurality of associated audio streams; and
an audio stream module device configured to output at least two of the plurality of associated audio streams substantially simultaneously, a first audio stream of the at least two of the plurality of associated audio streams is associated with a primary video stream of a picture in picture screen and a second audio stream of the at least two of the plurality of associated audio streams is associated with a secondary video stream of the picture in picture screen.

2. The system of claim 1, further comprising a video output module configured to output the video stream.

3. The system of claim 2, wherein the video stream and the at least two of the plurality of associated audio streams are output substantially simultaneously.

4. The system of claim 1, wherein the audio stream comprises packetized elementary streams.

5. The system of claim 1, wherein a first audio stream of the at least two of the plurality of associated audio streams is output on a primary audio system and a second audio stream of the at least two of the plurality of associated audio streams is output through a wireless medium.

6. (canceled)

7. (canceled)

8. A method comprising
receiving a program stream with video packets and audio packets, the audio packets comprising at least a first language and a second language;
substantially simultaneously processing the audio packets comprising the first language and the audio packets comprising the second language to separate the audio packets into a first audio stream of the first language for use by a first user and a second audio stream of the second language for use by a second user; and
outputting the first audio stream and the second audio stream substantially simultaneously and synchronously with the video packets, the first audio stream associated with a primary video stream of a picture in picture screen and the second audio stream associated with a secondary video stream of the picture in picture screen.

9. The method of claim 8, further comprising outputting the first audio stream on a primary audio system and outputting the second audio stream through a wireless medium.

10. (canceled)

11. (canceled)

12. The method of claim 11, wherein the audio packets comprising the primary language are muted while the audio packets comprising the secondary language are broadcast.

13. A system comprising
means for receiving a program stream with video packets and audio packets, the audio packets comprising at least a first language and a second language;
means for substantially simultaneously processing the audio packets comprising the first language and the audio packets comprising the second language; and
means for outputting the audio packets comprising the first language for use by a first user and the audio packets comprising the second language for use for use by a second user, the audio packets comprising the first language and the audio packets comprising the second language being output substantially simultaneously and synchronously with the video packets, the audio packets comprising the first language being associated with a primary video stream of a picture in picture screen and the audio packets comprising the second language being associated with a secondary video stream of the picture in picture screen.

14. The system of claim 13, further comprising means for outputting the audio packets comprising the first language on a primary audio system.

15. The system of claim 13, further comprising means for outputting the audio packets comprising the second language through a wireless medium.

16. (canceled)

17. (canceled)

18. The system of claim 17, further comprising means for muting the packets comprising the primary language while the audio packets comprising the secondary language are broadcast.

19. The system of claim 13, wherein the audio packets comprise at least a third language.

20. The system of claim 19, further comprising means for associating the audio packets comprising the third language with a primary video stream of a picture in picture screen.
